(19) United States
(12) Patent Application Publication
(10) Pub. No.: US 2026/0081246 A1
(43) Pub. Date: Mar. 19, 2026

(54) METHOD FOR REMOVING SURFACE IMPURITIES FROM SPENT CATHODE ACTIVE MATERIALS

(71) Applicant: NISSAN NORTH AMERICA, INC., Franklin, TN (US)

(72) Inventors: Zongtang FANG, Northville, MI (US); Kulwinder DHINDSA, Westland, MI (US); Javier PARRONDO, Novi, MI (US)

(21) Appl. No.: 18/782,899

(22) Filed: Jul. 24, 2024

(51) Int. Cl. H01M 10/54; H01M 4/02; H01M 4/505; H01M 4/525

(52) U.S. Cl. CPC H01M 10/54; H01M 4/505; H01M 4/525; H01M 2004/028

(57) ABSTRACT

A method is provided for recycling a cathode active material. The method includes reacting spent cathode active material particles with an alkaline solution to form a reaction mixture containing a metal fluoride and solid cathode active material particles, and filtering the reaction mixture to remove the metal fluoride and separate the solid cathode active material particles from the reaction mixture. The method further includes mixing the solid cathode active material particles with a solid lithium material to form relithiated cathode active material particles, and heating the relithiated cathode active material particles to form the cathode active material. The alkaline solution comprises water and at least one hydroxide selected from the group consisting of: sodium hydroxide, potassium hydroxide and lithium hydroxide. The spent cathode active material particles comprise fluorine and lithium.

### BACKGROUND

### Field of the Invention

The present invention generally relates to a method of removing surface impurities from a spent cathode active material so that the spent cathode active material can be recycled to form a new cathode active material. The method includes reacting the spent cathode active material with an alkaline solution to form a reaction mixture containing a metal fluoride and solid cathode active material particles, and filtering the reaction mixture to remove the metal fluoride. The method further includes drying the solid cathode active material particles, mixing the solid cathode active material particles with a solid lithium material to form relithiated cathode active material particles, and heating the relithiated cathode active material particles to form a cathode active material. The alkaline solution comprises water and at least one hydroxide selected from the group consisting of: sodium hydroxide, potassium hydroxide and lithium hydroxide. The spent cathode active material comprises fluorine and lithium. The present invention also relates to a system for removing surface impurities from a spent cathode active material.

### Background Information

Lithium-based batteries that include lithium metal anodes or lithium-based cathode material are desirable because they have a high energy density and, thus, can generate a large amount of power with a relatively thin electrode structure, thus permitting a reduction in the size of the battery as compared with other conventional batteries including anodes made of carbon or silicon.

Cathode active materials are one of the most expensive components in lithium-ion batteries. In particular, cobalt is very expensive, and there is a limited supply of other metals typically used in cathode active materials for lithium-ion batteries, such as lithium nickel manganese cobalt oxide (LiNiMnCoO₂, also commonly referred to as “NMC”). Therefore, it is desirable to recycle cathode active materials once the batteries have been used by recovering the spent cathode active material, and processing the spent cathode active material to obtain a cathode active material that is sufficient for use in a new lithium-ion battery.

There are several known methods for indirectly recycling the cathode active material. For example, one conventional recycling method involves burning or melting the entire lithium-ion battery at a high temperature. However, this method is expensive and results in a large loss of lithium which must then be replenished. Another conventional recycling method involves hydrometallurgical processing of the cathode using a leaching agent to leach out individual metal precursors for the cathode active material. However, once the individual metal precursors have been recovered, the cathode active material must be re-synthesized to manufacture a new cathode active material. Therefore, it is desirable to directly recycle the used cathode material such that additional synthesis or manufacturing of the cathode active material from the individual metal precursors is not required.

Fluorine impurities in cathode active materials potentially have negative effects on battery performance and generally cannot be avoided in direct cathode recycling. Conventional methods for fluorine removal have several drawbacks. For example, one known method involves thermal calcination of the spent cathode active material to remove fluorine formed on the surface of the spent cathode active material by the binder, namely polyvinylidene fluoride (“PVDF”). However, this method only removes carbon fluoride and does not remove metal fluoride generated during battery cycling and may destroy the structure and morphology of the cathode active material during high-temperature calcination. Another known method involves using a solvent such as N-methyl-2-pyrrolidone (“NMP”) or triethyl phosphate (“TEP”) to remove the fluorine. However, the solvents are not environmentally friendly and are not able to remove metal fluoride impurities either. A further method involves hydrothermal treatment of the spent cathode active material in an aqueous alkaline solution to remove fluorine impurities followed by separation of the cathode active material from the solution. However, this method may need a relatively high temperature (>180° C.) and a long reaction time (>15 hours). The morphology of the cathode active material can be potential destroyed due to the relatively high temperature.

Therefore, further improvement is needed to sufficiently remove fluorine from the spent cathode active material without adversely affecting the morphology or structure of the cathode material and with minimal environmental impact. In particular, it is desirable to generate recycled cathode active materials in which the fluorine impurities on the surface of the spent cathode active material have been removed as much as possible, thereby increasing the specific capacity of lithium-ion batteries that use such recycled cathode active materials.

### SUMMARY

It has been discovered that fluorine impurities can be removed from spent cathode active material particles such as NMC to a greater degree without adversely affecting the morphology or structure of the cathode active material by hydrothermal reaction of the spent cathode active material with an alkaline solution containing an oxidative additive. By performing the hydrothermal reaction in the presence of an oxidative additive, the reaction temperature and pressure can be lowered, thereby potentially mitigating adverse effects on the morphology and/or structure of the cathode active material.

Furthermore, it has been discovered that the relithiation of the cathode active material can be performed separately in the solid phase after the fluorine impurities have been removed and filtered out. By performing solid phase relithiation as a separate step, the hydrothermal reaction can be performed with an alkaline solution that does not contain lithium hydroxide. Because sodium hydroxide and potassium hydroxide can be more effective to remove fluorine than lithium hydroxide.

Therefore, it is desirable to provide a method for directly recycling the cathode active material of a used battery by hydrothermal reaction of a spent cathode active material with an alkaline solution to remove fluorine impurities, filtration of the fluorine impurities from the cathode active material, and solid phase relithiation of the cathode active material.

In view of the state of the known technology, one aspect of the present disclosure is to provide a method of recycling a cathode active material in which fluorine impurities are substantially removed without adversely affecting the morphology and/or structure of the cathode active material. The method includes reacting spent cathode active material particles with an alkaline solution to form a reaction mixture containing a metal fluoride and solid cathode active material particles, and filtering the reaction solution to remove the metal fluoride. The method further includes separating the solid cathode active material particles from the reaction mixture, mixing the solid cathode active material particles with a solid lithium material to form relithiated cathode active material particles, and heating/sintering the relithiated cathode active material particles to form the cathode active material. The alkaline solution comprises water and at least one hydroxide selected from the group consisting of: sodium hydroxide, potassium hydroxide and lithium hydroxide. The spent cathode active material particles comprise fluorine and lithium.

By performing solid phase relithiation as a separate step, the hydrothermal reaction can be performed with an alkaline solution that contains sodium hydroxide and/or potassium hydroxide, which can remove more fluorine than lithium hydroxide alone, thereby allowing for a more efficient removal of fluorine impurities in the hydrothermal reaction step. Furthermore, by performing the hydrothermal reaction with an oxidative additive, adverse effects on the morphology and/or structure of the cathode active material can be mitigated because the reaction temperature and pressure can be lowered.

Another aspect of the present disclosure is to provide a system for recycling a cathode active material. The system comprises a hydrothermal reactor, a filter, a drier, a mixer and a sintering furnace. The hydrothermal reactor has a first inlet and a first outlet. The filter is connected to the first outlet and has a second outlet. The drier is connected to the second outlet and has a third outlet. The mixer is connected to the third outlet and has a fourth outlet. The sintering furnace is connected to the fourth outlet.

By using a separate mixer for the solid phase relithiation, rather than performing relithiation in the hydrothermal reactor, the hydrothermal reaction can be performed with an alkaline solution that contains sodium hydroxide and/or potassium hydroxide, thereby allowing for a more efficient removal of fluorine impurities than with lithium hydroxide.

### BRIEF DESCRIPTION OF THE DRAWINGS

Referring now to the attached drawings which form a part of this original disclosure:

FIG. 1 is an illustrated flow chart showing a process of producing a cathode active material according to a first embodiment;

FIG. 2 is a schematic view of a system for producing a cathode active material according to a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

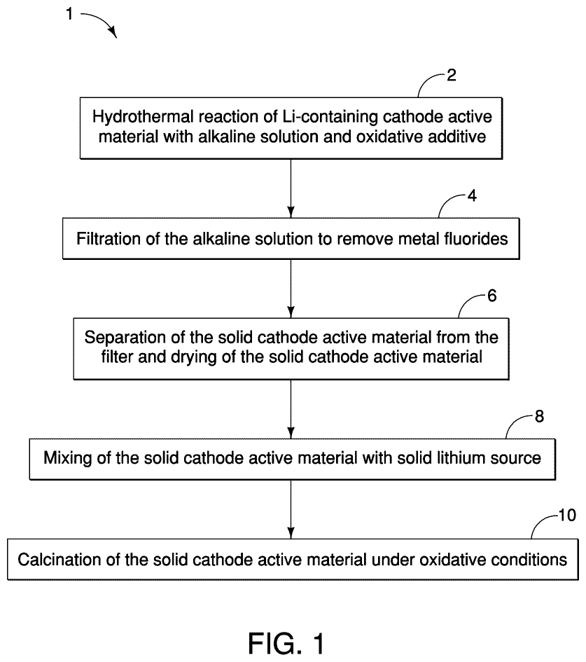

Referring initially to FIG. 1, a process 1 of producing a cathode active material from spent cathode active material is illustrated in accordance with a first embodiment. The spent cathode active material can be removed from a used lithium-ion battery in any suitable manner. The lithium-ion battery may be any suitable lithium-ion battery and can be a battery that was used in a vehicle, a mobile device, a laptop computer or other suitable personal electronic device. The spent cathode active material is a lithium-containing cathode active material. For example, the lithium-containing cathode active material can be NMC, lithium nickel cobalt aluminum oxide having the formula LiNiₓCo_{y}Al_{z}O₂, where x+y+z=1 (“NCA”), lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), doped/coated materials, and mixtures thereof. The spent cathode active material is preferably NMC.

Although the first embodiment relates to a spent cathode active material containing lithium from a lithium-ion battery, it should be understood to those skilled in the art that the following process may also be used for spent cathode active material from a potassium-or sodium-ion battery.

In Step 2, the lithium-containing spent cathode active material is subjected to hydrothermal reaction with an alkaline solution and an oxidative additive. The alkaline solution contains water and at least one alkali metal hydroxide. For example, the alkaline solution contains sodium hydroxide, potassium hydroxide, lithium hydroxide or mixtures thereof. The alkaline solution preferably contains at least one of sodium hydroxide and potassium hydroxide, and more preferably sodium hydroxide, since those compounds remove more fluorine from the surface of the cathode active material than lithium hydroxide alone. The concentration of the at least one hydroxide compound in the alkaline solution can be any suitable amount, but the concentration of the alkali metal hydroxide is approximately 3 M (mol/L) to 4 M (mol/L).

The oxidative additive includes at least one of oxygen (O₂), ozone (O₃), hydrogen peroxide (H₂O₂), lithium peroxide (Li₂O₂), sodium peroxide (Na₂O₂), potassium peroxide (K₂O₂), sodium superoxide (NaO₂), and potassium superoxide (KO₂). The oxidative additive is preferably oxygen or ozone, since the peroxides and superoxides are reactive to decompose at elevated temperatures. Furthermore, use of an oxygen or ozone additive allows the hydrothermal reaction to be performed in a flow reactor. A molecular ratio of the oxidative additive to the alkaline solution ranges from 1:5 to 1:1.

The hydrothermal reaction is performed at a temperature of 100° C. to 150° C., preferably 125° C. for any suitable amount of time. By maintaining the hydrothermal reaction temperature within this range, adverse effects on the morphology and structure of the cathode active material can be prevented. The reaction time is preferably two hours or more, depending on the amount of fluorine impurities, alkaline solution and oxidative additive. For example, the reaction time for the hydrothermal reaction of step 2 ranges from approximately two hours to twelve hours.

The hydrothermal reaction is performed at a pressure of approximately 1 bar to 5 bar, depending on the reaction temperature, the volume of liquid in the hydrothermal reactor, and the amount of oxidative additive. For the hydrothermal reaction, a total liquid volume of solution relative to the total mass of the spent cathode active material is controlled within a range of 5:1 (ml/g) to 20:1 (ml/g).

The hydrothermal reaction can be performed in any suitable vessel configured to carry out the hydrothermal reaction between the spent cathode active material, the alkaline solution and the oxidative additive. For example, the hydrothermal reaction can be performed in an autoclave. Alternatively, if the oxidative additive is oxygen or ozone, a flow reactor can be used to carry out the hydrothermal reaction. The hydrothermal reaction is preferably carried out in a flow reactor.

In Step 4, the alkaline solution is filtered to remove metal fluorides generated by the hydrothermal reaction. In particular, during the hydrothermal reaction, the fluorine impurities on the surface of the spent cathode active material react with the alkali metal in the hydroxide of the alkaline solution, thereby forming alkali metal fluoride(s). The filtration step removes the metal fluorides generated by the hydrothermal reaction. For example, when the alkaline solution includes sodium hydroxide, the filtration step removes sodium fluoride, whereas if the alkaline solution includes lithium hydroxide, the filtration step removes lithium fluoride.

The filter is any suitable filter and is selected based on the size of the metal fluoride particles. The filter is preferably a Buckner filter and has a size of approximately 4 μm to 8 μm. After filtration, the alkaline solution contains the alkali metal hydroxide(s), the solid cathode active material and a small amount of metal fluoride(s). Preferably, after filtration, the alkaline solution contains less than 5% by weight of metal fluoride(s) relative to a weight % of the cathode active material.

In Step 6, the alkaline solution is separated from the solid cathode active material remaining in the solution. The alkaline solution is preferably separated from the solid cathode active material by drying. The solid cathode active material can be dried in any suitable manner. For example, the alkaline solution can be dried at a temperature of 60° C. to 100° C. under vacuum for approximately two to three hours.

In Step 8, solid-phase mixing is performed to relithiate the solid cathode active material. For example, the solid cathode active material is mixed with a solid lithium source at room temperature (approximately 25° C.). The solid lithium source is any suitable lithium source, such as lithium hydroxide (LiOH), lithium oxide (Li₂O), lithium carbonate (Li₂CO₃), lithium nitrate (LiNO₃), lithium oxalate (Li₂C₂O₄), lithium acetate (LiOOC₂H₃), or mixtures thereof. The solid cathode active material is mixed with the solid lithium source in any suitable mixing ratio to relithiate the solid cathode active material. For example, the molecular mixing ratio of the lithium source to the cathode active material is approximately 2:10 to 3:10. The solid-phase mixing can be performed using any suitable mixing apparatus. For example, the solid-phase mixing can be performed in an industrial mixer.

In Step 10, the solid, relithiated cathode active material is subjected to calcination under oxidative conditions. The calcination is performed in a single apparatus with multiple temperatures under oxygen flow. The volume of oxygen flowed per minute over the material is within a range of 1:10 to 1:1 cm³/g. The calcination can be performed in any suitable apparatus, such as a heater or a furnace, in which oxygen can be flowed over the cathode active material during calcination. For example, the calcination may be performed in a tube furnace.

In the calcination step, the relithiated cathode active material is oxidized at a temperature of 350° C. to 650° C. for approximately three hours to six hours, depending on the nature of relithiated cathode active material. The relithiated cathode active material is also sintered in the calcination apparatus at any suitable temperature below the melting point of the solid relithiated cathode active material. For example, the sintering temperature is preferably 750° C. to 950° C. The sintering can be performed at a pressure of approximately 1 atm for approximately eight hours to fifteen hours. It should be understood that the low temperature oxidation before the sintering step can be performed in multiple steps.

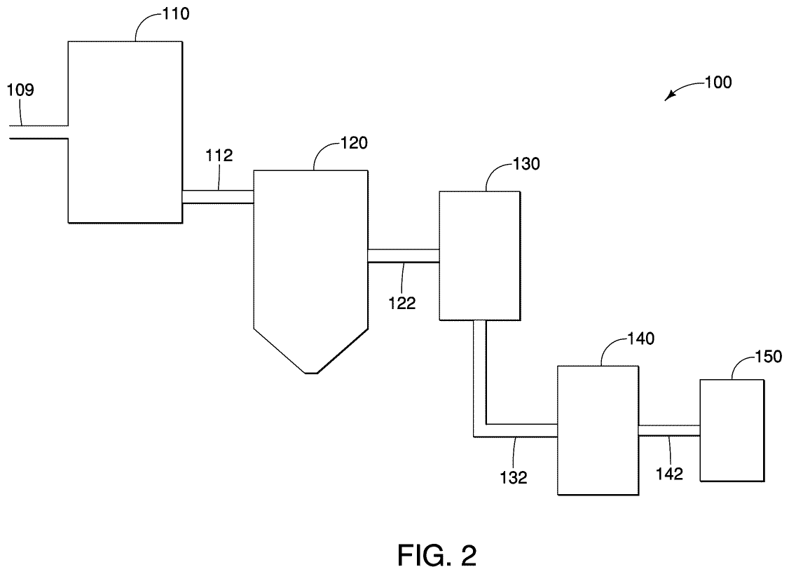

FIG. 2 shows a system 100 for producing a cathode active material from spent cathode active material in accordance with a second embodiment. The spent cathode active material can be removed from a used battery in any suitable manner. The battery may be any suitable lithium-, potassium-, or sodium-ion battery and can be a battery that was used in a vehicle, a mobile device, a laptop computer or other suitable personal electronic device. The battery is preferably a lithium-ion battery.

The spent cathode active material is preferably a lithium-containing cathode active material. For example, the lithium-containing cathode active material can be NMC, NCA, lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), doped/coated materials, and mixtures thereof. The spent cathode active material is preferably NMC.

The system 100 includes a feed inlet 109 for introducing the spent cathode active material into a hydrothermal reactor 110, which are separated from anode materials and current collectors. The hydrothermal reactor 110 is configured to carry out a hydrothermal reaction between the spent cathode active material, an alkaline solution and an oxidative additive. The alkaline solution can contain water and at least one of: sodium hydroxide, potassium hydroxide and lithium hydroxide. The alkaline solution preferably contains sodium hydroxide and/or potassium hydroxide, since those compounds remove more fluorine from the surface of the cathode active material than lithium hydroxide alone. The concentration of the at least one hydroxide compound in the alkaline solution is approximately 3 M (mol/L) to 4 M (mol/L).

The oxidative additive includes at least one of oxygen (O₂), ozone (O₃), hydrogen peroxide (H₂O₂), lithium peroxide (Li₂O₂), sodium peroxide (Na₂O₂), potassium peroxide (K₂O₂), sodium superoxide (NaO₂), and potassium superoxide (KO₂). The oxidative additive is preferably oxygen or ozone. A molecular ratio of the oxidative additive to the alkaline solution in the hydrothermal reactor 110 ranges from 1:5 to 1:1.

The hydrothermal reactor 110 is any suitable vessel configured to carry out the hydrothermal reaction between the spent cathode active material, the alkaline solution and the oxidative additive to form alkali metal fluoride(s) by reaction of fluorine impurities on the surface of the spent cathode active material with the alkali metal in the hydroxide of the alkaline solution. For example, the hydrothermal reactor 110 can be an autoclave. Alternatively, if the oxidative additive is oxygen or ozone, the hydrothermal reactor 110 can be a flow reactor. The hydrothermal reactor 110 is preferably a flow reactor.

The hydrothermal reactor 110 is configured to operate at a temperature of 100° C. to 150° C., preferably 125° C. By maintaining the hydrothermal reaction temperature within this range, adverse effects on the morphology and structure of the cathode active material can be prevented. The reaction time is preferably two hours or more, depending on the amount of fluorine impurities, alkaline solution and oxidative additive. For example, the reaction time for the hydrothermal reactor 110 ranges from approximately two hours to twelve hours.

The hydrothermal reactor 110 is configured to operate at a pressure of approximately 1 bar to 5 bar, depending on the reaction temperature, the volume of liquid in the hydrothermal reactor, and the amount of oxidative additive. The hydrothermal reactor 110 is also configured to be formed of suitable materials and have a suitable size to contain the alkaline solution, the spent cathode active material and the oxidative additive such that a total liquid volume of solution relative to the total mass of the spent cathode active material can be controlled within a range of 5:1 (ml/g) to 20:1 (ml/g).

The system 100 also includes an outlet 112 from the hydrothermal reactor 110. The outlet 112 is configured to feed the alkaline solution containing the oxidative additive, the spent cathode active material, and the metal fluorides to a filter 120.

The filter 120 is configured to remove metal fluorides generated by the reaction in the hydrothermal reactor 110. For example, when the alkaline solution includes sodium hydroxide, the filter 120 is configured to remove sodium fluoride, whereas if the alkaline solution includes lithium hydroxide, the filter 120 is configured to remove lithium fluoride.

The filter 120 is any suitable filter and is selected based on the size of the metal fluoride particles. The filter 120 is preferably a Buckner filter and has a pore size of approximately 4 μm to 8 μm.

The filter 120 includes an outlet 122 for the solid cathode active material remaining after filtration. After filtration, the solid cathode active material is separated from the filter 120 and sent out of the filter 120 through outlet 122. For example, after filtration, the solid cathode active material remains above the filter paper and must be removed from the filter 120, while the alkaline solution remains at the bottom of the filter 120 below the filter paper and can optionally be removed via another outlet. After filtration, the alkaline solution preferably contains less than 5% by weight of metal fluoride(s) relative to a weight % of the cathode active material.

The outlet 122 is configured to feed the solid cathode active material separated from the filter 120 to a drier 130. The drier 130 is configured to remove any remaining moisture from the solid cathode active material. The drier 130 is configured to dry the solid cathode active material in any suitable manner. For example, the drier 130 is configured to dry the solid cathode active material at a temperature of 60° C. to 100° C. under vacuum for approximately two to three hours.

The system 100 includes an outlet 132 from the drier 130. The outlet 132 is configured to feed the dried solid cathode active material, in which the vast majority of metal fluorides have been removed, to a mixer 140.

The mixer 140 is configured to mix the dried solid cathode active material with a solid lithium source at room temperature (approximately 25° C.) to relithiate the solid cathode active material. The mixer 140 is any suitable solid-phase mixer configured to operate at room temperature. For example, the mixer 140 is an industrial solid-phase mixer. The mixer 140 is configured agitate the dried solid cathode active material with the solid lithium source at a blade tip speed of up to 100 m/s for approximately 10 minutes to 30 minutes, to relithiate the solid cathode active material.

The solid lithium source is any suitable lithium source, such as lithium hydroxide (LiOH), lithium oxide (Li₂O), lithium carbonate (Li₂CO₃), lithium nitrate (LiNO₃), lithium oxalate (Li₂C₂O₄), lithium acetate (LiOOC₂H₃), or mixtures thereof. The solid cathode active material is mixed with the solid lithium source in any suitable mixing ratio to relithiate the solid cathode active material. For example, the molecular mixing ratio of the lithium source to the solid cathode active material is approximately 2:10 to 3:10.

The system 100 includes an outlet 142 from the mixer 140. The 142 is configured to feed the relithiated cathode active material to a heater 150. The relithiated cathode active material contains mostly a lithium-containing cathode active material and generally less than 0.01% by weight of fluorine-based impurities such as metal fluorides.

The heater 150 is any suitable heater configured to perform calcination of the relithiated cathode active material. For example, the heater 150 is any suitable apparatus configured to operate at multiple temperatures under oxidative conditions. The heater 150 is preferably a furnace, such as a tube furnace.

The heater 150 is configured to operate at any suitable temperature below the melting point of the solid relithiated cathode active material. For example, the heater 150 is configured to operate at a temperature of 350° C. to 650° C. for approximately three hours to six hours, depending on the nature of relithiated cathode active material, to oxidize the relithiated cathode active material. The heater 150 is also configured to operate at a temperature of 750° C. to 950° C. at a pressure of approximately 1 atm for approximately eight hours to fifteen hours to sinter the relithiated cathode active material.

The heater 150 is also configured to flow oxygen over the cathode active material during calcination. The heater 150 is configured to control the amount of oxygen flowed over the material. The volume of oxygen flowed per minute over the material is within a range of 1:10 to 1:1 cm³/g.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A method of recycling a cathode active material, the method comprising:
reacting spent cathode active material particles with an alkaline solution to form a reaction mixture containing a metal fluoride and solid cathode active material particles;
filtering the reaction mixture to remove the metal fluoride and separate the solid cathode active material particles from the reaction mixture;
mixing the solid cathode active material particles with a solid lithium material to form relithiated cathode active material particles; and
heating the relithiated cathode active material particles to form the cathode active material,
the alkaline solution comprising water and at least one hydroxide selected from the group consisting of: sodium hydroxide, potassium hydroxide and lithium hydroxide, and
the spent cathode active material particles comprising fluorine and lithium.

2. The method according to claim 1, wherein
the alkaline solution comprises sodium hydroxide.

3. The method according to claim 1, wherein
the spent cathode active material particles are reacted with the alkaline solution and an oxidative additive to form the reaction mixture.

4. The method according to claim 1, wherein
the oxidative additive comprises at least one selected from the group consisting of: O₂, O₃, H₂O₂, Li₂O₂, Na₂O₂, K₂O₂, NaO₂ and KO₂.

5. The method according to claim 1, wherein
a concentration of the at least one hydroxide in the alkaline solution ranges from 3M to 5M.

6. The method according to claim 1, wherein
the spent cathode active material particles comprise at least one selected from the group consisting of: lithium nickel manganese cobalt oxide, lithium nickel cobalt aluminum oxide, lithium cobalt oxide, lithium nickel oxide, lithium manganese oxide, and lithium nickel manganese oxide.

7. The method according to claim 1, wherein
the spent cathode active material particles are reacted with the alkaline solution and the oxidative additive at a temperature of 100° C. to 150° C.

8. The method according to claim 1, wherein
the solid lithium material comprises at least one selected from the group consisting of: LiOH, Li₂O, Li₂CO₃, LiNO₃, Li₂C₂O₄, and LiOOC₂H₃.

9. The method according to claim 1, wherein
the solid cathode active material particles are dried before being mixed with the solid lithium material.

10. The method according to claim 9, wherein
the drying is performed at a temperature of 60° C. to 100° C.

11. The method according to claim 1, wherein
the heating the relithiated cathode active material particles to form the cathode active material comprises oxidizing the relithiated cathode active material particles at a first temperature and sintering the relithiated cathode active material particles at a second temperature.

12. The method according to claim 1, wherein
the first temperature ranges from 350° C. to 650° C., and the second temperature ranges from 750° C. to 950° C.

13. A system for recycling a cathode active material, the system comprising:
a hydrothermal reactor having a first inlet and a first outlet;
a filter connected to the first outlet and having a second outlet;
a drier connected to the second outlet and having a third outlet;
a mixer connected to the third outlet and having a fourth outlet; and
a heater connected to the fourth outlet.

14. The system according to claim 13, wherein
the hydrothermal reactor is an autoclave or a flow reactor.

15. The system according to claim 13, wherein
the hydrothermal reactor is configured to operate at a temperature of 100° C. to 150° C.

16. The system according to claim 13, wherein
the filter has a size of approximately 4 μm to 8 μm.

17. The system according to claim 13, wherein
the drier is configured to operate at a temperature of 60° C. to 100° C.

18. The system according to claim 13, wherein
the heater is configured to operate at first temperature of approximately 350° C. to 650° C. and a second temperature of approximately 700° C. to 950° C.

19. The system according to claim 13, wherein
the heater is a calcination furnace configured to flow oxygen at a temperature of at least 350° C.
